(19) United States
(12) Patent Application Publication
(10) Pub. No.: US 2009/0140603 A1
(43) Pub. Date: Jun. 4, 2009

(54) Electrostatic charge generating assembly

(75) Inventor: Dean Aslam, Okemos, MI (US)

Correspondence Address: Ian C. McLeod;IAN C. McLEOD, P.C., 2190 Commons Parkway, Okemos, MI, 48864, US

(73) Assignee: Board of Trustees of Michigan State University, East Lansing, MI (US)

(21) Appl. No.: 12/313,850

(22) Filed: Nov. 25, 2008

Related U.S. Application Data
(60) Provisional application No. 61/005,326, filed on Dec. 4, 2007.

(51) Int. Cl. H02N 1/04; G09B 23/18

(52) U.S. Cl. 310/310; 310/1

(57) ABSTRACT

The present invention provides for a static charge generating assembly. The static charge generating assembly is comprised of: (a) a support structure built from a plurality of friction fit building elements; (b) positive and negative static charge generating wheels; (c) a belt wrapped around the static charge generating wheels; (d) a power source electrically coupled to a driving means for rotating at least one of the static charge generating wheels and the belt at a preselected rotational speed; and (e) positive and negative electrodes secured to the support structure adjacent to the belt. Each of the electrodes is mounted on at least one of the friction fit building elements positioned adjacent to a static charge generating wheel operable to collect static charge. Separate positive and negative static charge collectors are used for storing the negative and positive static charges from the electrodes.

### CROSS-REFERENCE TO RELATED APPLICATIONS

This application claims the benefit of U.S. Provisional Application Ser. No. 61/005,326, filed Dec. 4, 2007.

### STATEMENT REGARDING FEDERALLY SPONSORED RESEARCH OR DEVELOPMENT

Not Applicable.

### REFERENCE TO A “COMPUTER LISTING APPENDIX SUBMITTED ON A COMPACT DISC”

Not Applicable.

### BACKGROUND OF THE INVENTION

(1) Field of the Invention

The present invention relates generally to an electrostatic charge generating assembly.

(2) Description of the Related Art

A Van de Graaff generator is an electrostatic generating machine which uses a moving belt to accumulate very high voltages. Typically, these voltages are accumulated on a hollow metal globe. The potential differences achieved in modern Van de Graaff generators can reach 5 megavolts (5,000,000 V). Applications for these high voltage generators include driving X-ray tubes, accelerating electrons to sterilize food and process materials, and accelerating protons for nuclear physics experiments. The Van de Graaff generator can be thought of as a constant-current source connected in parallel with a capacitor and a very large electrical resistance.

A simple Van de Graaff generator typically consists of a belt of silk, or a similar flexible dielectric material, running over two pulleys, one of which is surrounded by a hollow metal sphere. Two electrodes (upper and lower), in the form of sharply pointed cones, are positioned respectively, one near to the bottom of the pulley (lower) and one inside the sphere (upper). The upper electrode is connected to the sphere, and a high DC potential (with respect to earth) is applied to the lower electrode; a positive potential in this example.

The high voltage ionizes the air at the tip of the lower electrode, repelling (spraying) positive charges onto the belt, which then carries them up and inside the sphere. This positive charge induces a negative charge to the upper electrode and a positive charge to the sphere (to which the upper electrode is connected). The high potential difference ionizes the air inside the sphere, and negative charges are repelled from the upper electrode and onto the belt, discharging it. As a result of the Faraday cage effect, positive charge on the upper electrode migrates to the sphere regardless of the sphere's existing voltage. As the belt continues to move, a constant charging current travels via the belt, and the sphere continues to accumulate positive charge until the rate that charge is being lost (through leakage and corona discharges) equals the charging current. The larger the sphere and the farther it is from ground, the higher will be its final potential.

A further method for building Van de Graaff generators includes using the triboelectric effect. The two rollers for the belt are made of different materials, far from each other on the triboelectric series. When the belt comes into contact with one and is then separated, charge is transferred from the roller to the belt, and the roller becomes charged. When the belt comes into contact with the other roller and is then separated, charge is transferred from the belt to the roller, and that roller develops an opposite charge. The strong electromagnetic-field (e-field) from the rollers then induces a corona discharge at the tip of the pointed electrodes. The electrodes then transfer a charge to the outside of the globe. The remaining operation is otherwise the same as the voltage-injecting version discussed above. This type of generator is easier to build for science fair or homemade projects, since it typically does not require a potentially dangerous high voltage source. The trade-off is that it cannot build up as high of a voltage as the other type, and operation may become difficult under humid conditions (which can severely reduce triboelectric effects).

Since a Van de Graaff generator can supply the same small current at almost any level of electrical potential, it serves as an example of a nearly ideal current source. The maximum achievable potential is approximately equal to the sphere's radius multiplied by the e-field where corona discharges begin to form within the surrounding gas. For example, a polished spherical electrode 30 cm in diameter immersed in air at STP (which has a breakdown voltage of about 30 kV/cm) could be expected to develop a maximum voltage of about 450 kV.

In U.S. Pat. No. 1,991,236 to Van de Graaf et al. an electrostatic generator is described operable for the production of DC voltages, and also to apparatus including an electrostatic generator and an electrical device, such as an x-ray tube, operated thereby.

Since the advent of the Van de Graaff generator, various uses for electrostatic charge collection have evolved and been developed. Despite efforts to date, a need still remains for an effective electrostatic generator that can easily be assembled and disassembled and further is effective safe in use in a classroom setting for teaching and investigative purposes. A further need exists for a robotic and/or movable electrostatic generator capable of mobilizing charge delivery.

These and other objects of the present invention will become increasingly apparent with reference to the following drawing and preferred embodiments.

### SUMMARY OF THE INVENTION

The present invention provide for a static charge generating assembly comprising: (a) a support structure comprising a plurality of friction fit building elements which are electrically non-conductive; (b) positive and negative static charge generating wheels, wherein the wheels are spaced apart with respect to each other and secured on the support structure; (c) a belt wrapped around the spaced apart positive and negative static charge generating wheels; (d) a power source electrically coupled to a driving means for circumferentially rotating at least one of the positive and negative static charge generating wheels and the belt at a preselected rotational speed; (e) positive and negative electrodes secured to the support structure adjacent to the belt, wherein each of the electrodes is mounted on at least one of the friction fit building elements and the positive electrode is positioned adjacent to the positive static charge generating wheel and operable to collect the positive static charge and the other negative electrode is positioned adjacent to the negative static charge generating wheel operable to collect the negative static charge; and (f) separate positive and negative static charge collectors wherein each collector is mounted with respect to the positive and negative electrode respectively and are operable for storing the negative and positive static charges from the electrodes.

In an exemplary embodiment, each of the electrodes comprise a plurality of spaced apart electrically conductive lead wires connected to the separate static charge collectors. Each of the lead wires typically has terminals for transfer of the positive or the negative static charges to the charge collectors. In a further exemplary embodiment, the positive static charge collector comprises a container fabricated from a charge collecting material and adapted to receive and store the positive static charge from the terminal from the positive electrode. The positive charge collector can be a metal container defining an opening cavity at a first end adapted to be mounted on the terminal for collection of the static charge from the positive electrode. In a further embodiment, the terminal from the negative electrode is fabricated from an electrically conductive material and adapted to transfer negative static charge from the negative electrode to the negative static charge collector. The terminal for the negative electrode is typically coupled to a conductive wire adapted to allow for the negative static charge to transfer through the terminal to the negative static charge collector. In an exemplary embodiment, the positive and negative charge terminals are removably secured within the support structure.

The present disclosure provides for an exemplary assembly wherein the plurality of friction fit building elements each define a three dimensional geometry. The three dimensional geometries can be selected from the group consisting of rectangle, square, disk and combinations thereof. Generally, each of the building elements defines a plurality of sides and comprises: (i) a main body; (ii) at least one outwardly extending friction fit member on at least a first side defining a first geometry; and (iii) at least one friction fit receptacle defined on at least a second side defining a second geometry adapted to receive an outwardly extending friction fit member from another building element defining the first geometry. In a particular embodiment, the first geometry is selected from the group consisting of circle, triangle, square, rectangle, pentagon, hexagon, heptagon and octagon. In yet a further embodiment, the outwardly extending friction fit member defines a circular geometry and a hollow cavity portion in the center.

In an exemplary embodiment, the positive static charge generating wheel is fabricated from a material operable to generate negative charge along an outer side of the belt and wherein the negative static charge generating wheel is fabricated from a material operable to generate a positive charge along the outer side of the belt. In a further embodiment, the belt is fabricated from a rubber or a plastic material. The building elements are typically, fabricated from plastic.

In a further exemplary embodiment, the driving means comprises: (i) a large gear engaged with respect to a motor driven by the power source; and (ii) a small gear driven by the large gear and engaged with the negative static charge generating wheel. In a further embodiment, the power source defines a top surface of friction fit building elements and the support structure is positioned and supported on the top surface of the power source. The large gear, the small gear and the motor can be each removably mounted with respect to the support structure. In a further embodiment, the power source is embedded in at least one friction fit building element.

In an exemplary embodiment, the positive charge collecting assembly collects positive charge to deliver from about 1,000 to 100,000 volts. In a further embodiment, the positive charge collecting assembly collects positive charge to deliver from about 5,000 to 15,000 volts. The collected negative charge can be made operable to create an electrical discharge lightning effect when positioned in proximity to a positively charged source. In a further embodiment, the positive electrostatic charge generating wheel is further surrounded by a leather sleeve to increase positive charge generation. In yet a further embodiment, a heating element can be disposed internal to the belt and adapted to deliver heat to increase static charge generation.

The present disclosure provides for a kit having component parts capable of being assembled comprising: (a) a support structure comprising a plurality of friction fit building elements which are electrically non-conductive; (b) positive and negative static charge generating wheels to be spaced apart with respect to each other and secured on the support structure; (c) a belt to be wrapped around the spaced apart positive and negative static charge generating wheels; (d) a driving means for circumferentially rotating at least one of the positive and negative static charge generating wheels and the belt at a preselected rotational speed; (e) a connection means for providing a power source to be electrically coupled to the driving means; (f) positive and negative electrodes to be secured to the support structure adjacent to the belt, wherein each of the electrodes is mounted on at least one of the friction fit building elements and the positive electrode is to be positioned adjacent to the positive static charge generating wheel and operable to collect the positive static charge and the other negative electrode is to be positioned adjacent to the negative static charge generating wheel operable to collect the negative static charge; and (g) separate positive and negative static charge collectors to be mounted with respect to the positive and negative electrode respectively and are operable for storing the negative and positive static charges from the electrodes. The kit can further comprise instructions for assembly. In a further embodiment, the kit further comprises a power source. The power source can be a battery. In a further embodiment, the power source is embedded in at least one friction fit building element. The connection means can comprise a power chord operable to plug into a power source.

The present disclosure provides for a robotic electrostatic charge generating apparatus comprising: (a) an electrostatic charge generating assembly comprising a support structure and spaced apart positive and negative static charge generating wheels mounted with respect to the support structure surrounded by a belt and coupled to a driving means for rotating at least one of the positive or negative static charge generating wheels and the belt at a selected rotational speed; (b) separate positive and negative static charge collectors mounted with respect to positive and negative electrodes connected to the positive and negative static charge generating wheels respectively; (c) a power module connected to the driving means; and (d) a robotic assembly comprising a programmable element adapted to receive instructional data and effectuate adjustments in at least the rotational speed of the driving means. In a further embodiment, the robotic means further comprises: (i) a movable base, and (ii) robotically controlled motive means for moving the base from one place to another. The electrostatic charge generating assembly and the power module are each mounted with respect to the movable base.

In an exemplary embodiment, the support structure is comprised of a plurality of friction fit building elements. The power module can be a battery. In a further embodiment, the power module is embedded in at least one friction fit building element. In a further embodiment, the driving means is a plurality of gears driven by a motor wherein at least one of the gears mechanically drives at least one of the positive or negative electrostatic charge generating wheels. An exemplary assembly associated with the present disclosure further comprises an electronic control means in electronic communication with the robotically controlled motive means. In yet a further embodiment, the robotically controlled motive means comprises a plurality of wheels driven by the control means. A plurality of wheels can be comprised of four wheels. In yet a further embodiment, the robotically controlled motive means can be comprised of a tract for enabling movement of the base.

In an exemplary embodiment, the electronic control means is a microprocessor. In a further embodiment, the electronic control means is in electronic communication with the driving means to control the rotational speed of static charge generating wheels and the belt. In yet a further embodiment, the electronic control means is a microprocessor in wireless communication with a remote control device. The remote control device can be made operable to deliver instructional signals to the microprocessor to drive the robotically controlled motive means to move the robotic apparatus to a desired position. In yet a further embodiment, the remote control device is operable to deliver instructional signals to the microprocessor to drive the driving means to control the rotational speed of static charge generating wheels and the belt.

The present disclosure provides for an exemplary robotic assembly further comprising a humidity sensor connected to the electronic control means operable to measure surrounding environmental humidity. In a further embodiment, the rotational speed of the static charge generating wheels and the belt is adjusted as a result of the measurement made by the humidity sensor. In yet a further embodiment, the electronic control means is a programmable microprocessor operable to control the rotational speed of the static charge generating wheels and the belt in order to generate a desired voltage from the positive and negative charge collectors. In yet an even further embodiment, the assembly comprises signaling means for indicating when the environment has reached a target humidity value based on the humidity sensor. The signaling means can be visual characterized by at least one lighting feature lighting when the environment reaches a target humidity value. The signaling means can further be auditory and delivers an auditory noise when the environment reaches a target humidity value. In an exemplary embodiment, the charge collectors are operable to deliver a high voltage to a target. In yet a further embodiment, the target is bacteria and is destroyed upon delivery of high voltage when exposed to one of the charge collectors. In an exemplary embodiment, the voltage delivered is from about 5,000 to 100,000 volts.

The preset disclosure provides for an exemplary electrostatic charge generating apparatus comprising: (a) a plurality of electrostatic charge generating belt assemblies wherein each belt assembly is comprised of a support structure and spaced apart positive and negative static charge generating wheels mounted with respect to the support structure surrounded by a belt and coupled to a driving means for rotating at least one of the positive or negative static charge generating wheels and the belt at a selected rotational speed; (b) separate positive and negative static charge collectors mounted with respect to positive and negative electrodes connected to the positive and negative static charge generating wheels respectively; (c) a connection means for connecting the driving means to a power source; and (d) a base for supporting the plurality of belt assemblies. In a further embodiment, the base supports three circumferentially spaced apart belt assemblies. In yet a further embodiment, the support structure is constructed from a plurality of friction fit building elements. In an even yet a further embodiment, the plurality of belt assemblies are driven by a single motor.

### BRIEF DESCRIPTION OF THE DRAWINGS

FIG. 1 is a first side view illustrating an exemplary assembly associated with the present disclosure;

FIG. 2 is an opposite side view with respect to FIG. 1 of an exemplary assembly associated with the present disclosure;

FIG. 3 is a cross section view of a top portion taken along line 4-4 and 5-5 of an exemplary assembly associated with the present disclosure;

FIG. 4 is a cross section view along line 4-4 from FIG. 3 illustrating an exemplary positive electrode associated with the present disclosure;

FIG. 5 is a cross section view along line 5-5 from FIG. 3 illustrating an exemplary negative electrode associated with the present disclosure;

FIG. 6 is a prior art Van de Graaff generator;

FIG. 7 is a top section perspective view of an exemplary assembly associated with the present disclosure;

FIG. 8 illustrates an exemplary motor engaged with a gear for use with an exemplary assembly associated with the present disclosure;

FIG. 9 illustrates an exemplary audio indicating tool effective to illustrate electrostatic principals;

FIG. 10 illustrates an exemplary static enhancing brush associated with an exemplary assembly of the present disclosure;

FIG. 11 illustrates an exemplary resonance indication tool for use with an exemplary assembly associated with the present disclosure;

FIG. 12 illustrates an exemplary circuit board for use with an exemplary assembly associated with the present disclosure;

FIG. 13 is a side view of an exemplary robotic electrostatic charge generating assembly;

FIG. 14 illustrates a multi-belt assembly electrostatic charge apparatus.

### DESCRIPTION OF THE PREFERRED EMBODIMENTS

All patents, patent applications, government publications, government regulations, and literature references cited in this specification are hereby incorporated herein by reference in their entirety. In case of conflict, the present invention, including definitions, will control.

The present invention relates generally to a static charge generating assembly. In an exemplary embodiment, the static charge generating assembly is comprised of: (a) a support structure built from a plurality of friction fit building elements which are electrically non-conductive; (b) positive and negative static charge generating wheels, wherein the wheels are spaced apart with respect to each other and secured on the support structure; (c) a belt wrapped around the spaced apart positive and negative static charge generating wheels; (d) a power source electrically coupled to a driving means for circumferentially rotating at least one of the positive and negative static charge generating wheels and the belt at a preselected rotational speed; (e) positive and negative electrodes secured to the support structure adjacent to the belt, wherein each of the electrodes is mounted on at least one of the friction fit building elements and the positive electrode is positioned adjacent to the positive static charge generating wheel and operable to collect the positive static charge and the other negative electrode is positioned adjacent to the negative static charge generating wheel operable to collect the negative static charge; and (f) separate positive and negative static charge collectors wherein each collector is mounted with respect to the positive and negative electrode respectively and are operable for storing the negative and positive static charges from the electrodes.

FIGS. 1-5 illustrate an exemplary assembly associated with the present disclosure. As can be seen in a first side view in FIG. 1, assembly 10 is comprised of a support structure 100. Support structure 100 is built by interconnecting a plurality of friction fit building elements 101 that are electrically non-conductive. Exemplary friction fit building elements 101 can be any standard building blocks sold in industry including but not limited to, Legos™. Using building elements 101 allows for relatively easy assembly and disassembly of the support structure 100 and thus assembly 10. This further provides for effective investigation and learning of particular electrostatic principals associated with assembly 10. Building elements 101 are particular effective with children when used as a teaching tool since they can be generally regarding as toys. Typically, building elements 101 define a variety of three dimensional shapes, sizes and geometries.

In an exemplary embodiment, support structure 100 is constructed to support positive (12P) and negative (12N) static charge generating wheels (often referred to as pulley wheels, or pulleys and it should be noted that these terms can be used interchangeably). The wheels 12P and 12N are spaced apart with respect to each other and secured and/or mounted with respect to the support structure. A belt 14 is wrapped around both wheels 12P and 12N. As the static charge generating wheels 12P and 12N turn or rotate, belt 14 turns and rotates thereby generating static charges to be collected by collection devices to be described below. The rubbing of the positive charge generating wheel 12P against belt 14 induces a negative charge on outer side 114 of belt 14 as belt 14 rotates clockwise towards negative electrode 122. Similarly, the rubbing of the negative charge generating wheel 12N against belt 14 induces a positive charge on outer side 114 of belt 14 as belt 14 rotates clockwise towards positive electrode 121.

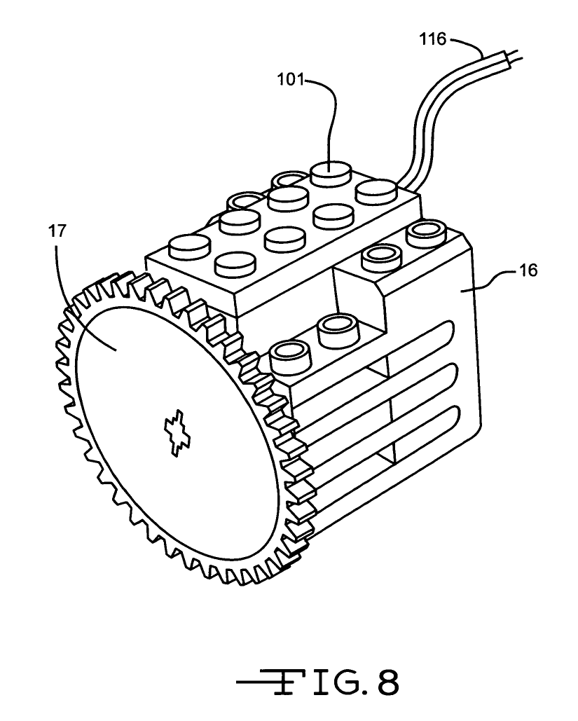

In an exemplary embodiment, a power source 18 is coupled to a driving means for circumferentially rotating at least one of the wheels 12P or 12N. As shown in FIGS. 1-5, driving means can be a motor 16 electrically connected to power source 18. FIGS. 1-5 illustrate an exemplary embodiment wherein motor 16 drives negative static charge generating wheel 12N via a gear mechanism. FIGS. 2 and 8 illustrate in greater detail an exemplary gear mechanism associated with the present disclosure. Motor 16 circumferentially rotates a first gear 17. First gear 17 is mechanically engaged with a second gear 19. Gear 19 is mechanically engaged with wheel 12N. First gear 17, second gear 19, and motor 16 are supported on the support structure 100. In an exemplary embodiment, motor 16 is constructed to interconnect with friction fit building elements 101. As shown in FIG. 8, motor 16 typically comprises an electrical chord 116 that allows for connection with an exemplary power source 18. In an exemplary embodiment, power source 18 comprises a battery thus allowing for it to be portable. Moreover, power source 18 can include on/off switches. In an exemplary embodiment, power source 18 includes a 9 Volt battery.

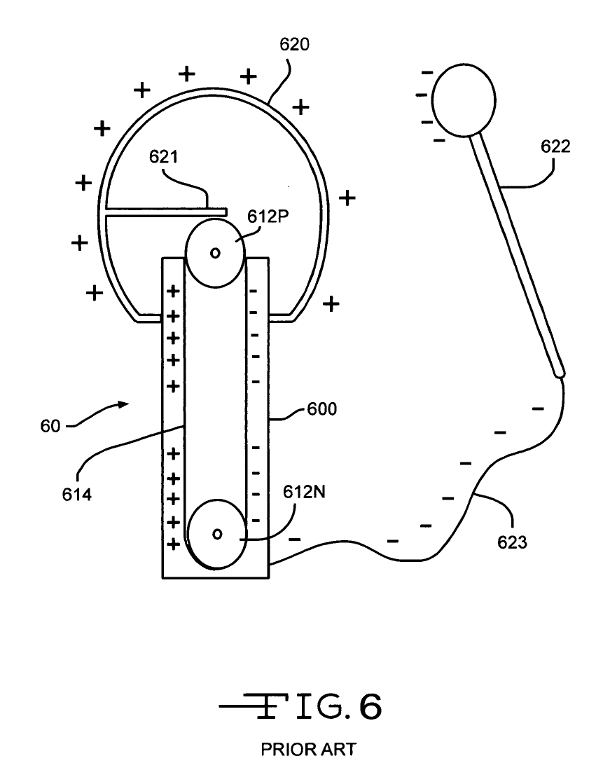

Referring to a prior art Van de Graaff generator as illustrated in FIG. 6, generator 60 is comprised of a support structure 600 supporting positive and negative static charge generating pulleys 612P and 612N. Belt 614 is wrapped around pulleys 612P and 612N and turns when a driving means turns either pulley. As belt 614 is turning, positive charge (represented by the [+] symbol) is collected in collection globe 620 via positive charge electrode 621 and negative charge is collected via a negative charge electrode (not shown) positioned in relative proximity of the rotating negative charge generating pulley 612N and connected to an electronic cable 623. The negative charge (represented by the [−] symbol) transfers through cable 623 which is typically insulated and is collected in wand 622. During operation, wand 622 and globe 620 are electronic polar opposites and can simulate “lightning” or at least illustrate electrostatic principals.

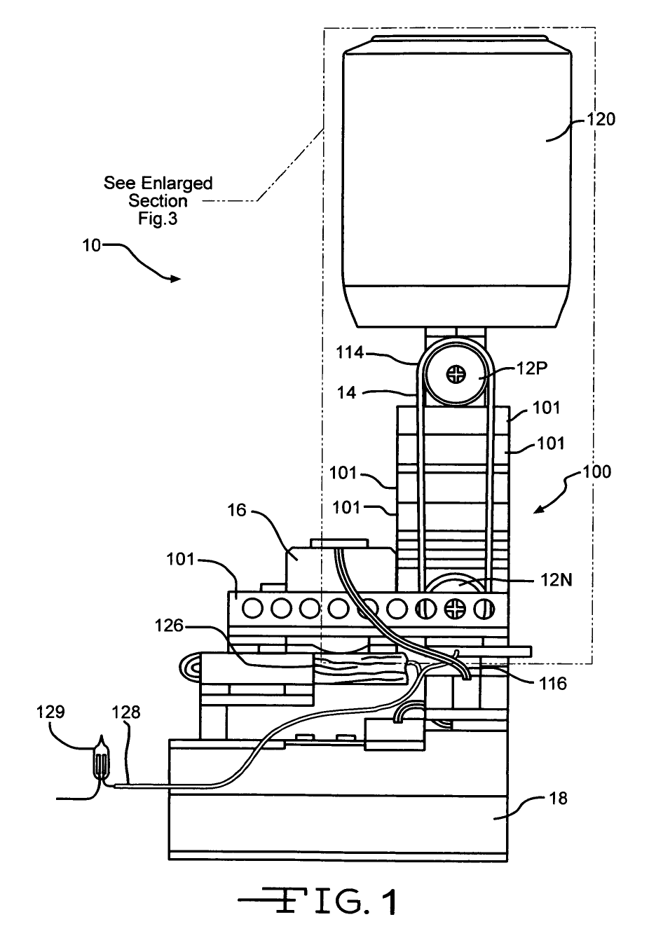

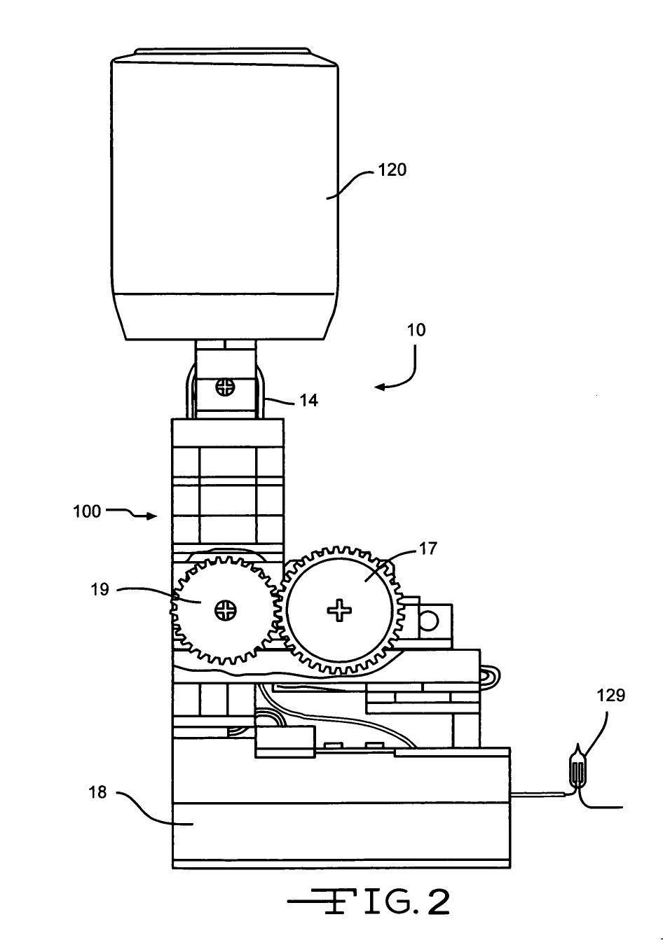

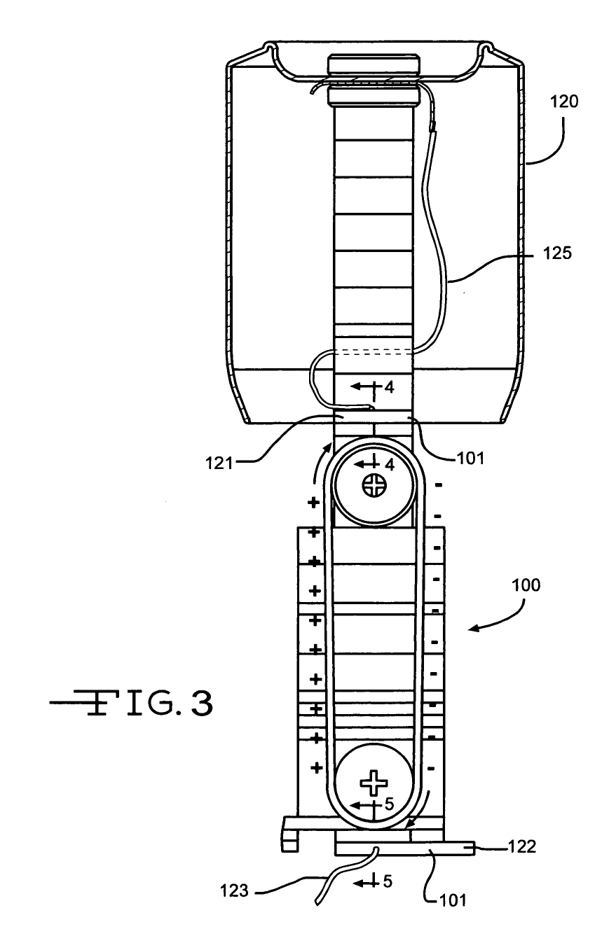

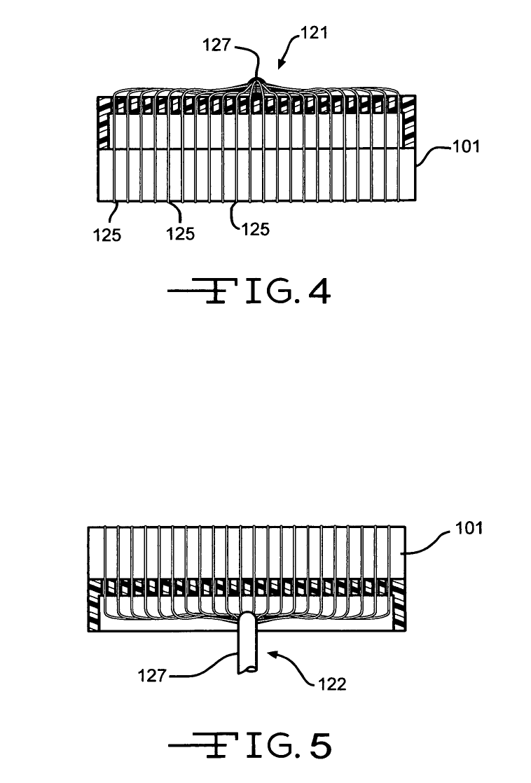

FIGS. 1-5 and 7-8 illustrate an exemplary electrostatic generator associated with the present disclosure. During operation of assembly 100, i.e., motor 16 drives negative static charge generating wheel 12N thereby turning belt 14 and positive charge generating wheel 12P, negative charge is collected by a negative electrode 122 and positive charge is collected via positive electrode 121. Each of positive (121) and negative (122) electrode are formed integral with at least one friction fit building element 101. In a particular embodiment, the electrodes are embedded in at least one friction fit building element. This can be clearly seen with respect to FIGS. 4 and 5 respectively. Electrodes 121 and 122 are each comprised of a plurality of electrically conductive leads 125. Leads 125 are operable to receive static charge and deliver that charge to a charge collector. In an exemplary embodiment, leads 125 are uniformly spaced apart with respect to each other. Typically, each of the leads 125 collect into a terminal 127 for transfer of the positive or the negative static charges to the charge collectors. As can be seen in FIG. 3, positive charge collector can 120 operates similarly to a globe in prior art Van de Graaff generators. Typically collector can 120 is removable and surrounds a top portion of support structure 100 such that that electrode 121 is substantially enclosed.

In an exemplary embodiment, electrode 121 is electrically connected to a wire 125 that allows for the charge to be transferred to another source with minimal resistance. Typically wire 125 is insulated. The charge is then collected in the can 120. Once charge is collected in can 120, assembly 10 can deliver a voltage through can 120. For example, if you place a small bulb near can 120, the light may turn on, or if a person touches the can, or places his or hand near the can, the hair on that person's hand or body may rise. At electrode 122, negative charge is collected and delivered via wire 123 to a negative charge collector 126. Negative charge collector 126 can be any conductive material capable of holding negative charge, for example copper or copper composite materials and is often formed in the shape of a plate. In an exemplary embodiment, as illustrated with respect to FIG. 1, collector 126 is connected to a light indicator having a wire 128 connected to a bulb 129 operable to light up upon receiving negative charge.

Positive static charge collector 120 typically comprises a container fabricated from a charge collecting material and adapted to receive and store the positive static charge from terminal 127 of positive electrode 121. In an exemplary embodiment, collector 120 can be a metal container defining an opening cavity at a first end adapted to be mounted on the terminal for collection of the static charge from the positive electrode. Typically positioned adjacent negative static charge generating wheel 12N is terminal 127 of negative electrode 122 and leads 125 are fabricated from an electrically conductive material adapted to transfer negative static charge from negative electrode 122 to the negative static charge collector 126. Conductive wire 123 is adapted to allow for the negative static charge to transfer through terminal 127 of electrode 122 to negative static charge collector 126. In an exemplary embodiment, the positive and negative electrodes 121 and 122 are removably secured within support structure 100.

Friction fit building elements 101 can define a plurality of unique and different three dimensional geometries. In an exemplary embodiment, the three dimensional geometries are selected from the group consisting of rectangle, square, disk and combinations thereof. Each of the building elements 101 define a plurality of sides and comprise: (i) a main body; (ii) at least one outwardly extending friction fit member on at least a first side defining a first geometry; and (iii) at least one friction fit receptacle defined on at least a second side defining a second geometry adapted to receive an outwardly extending friction fit member from another building element defining the first geometry. Exemplary first geometries include but are not limited to: circle, triangle, square, rectangle, pentagon, hexagon, heptagon and octagon. In a further exemplary embodiment, the outwardly extending friction fit member defines a circular geometry and a hollow cavity portion in the center. Building elements 101 are typically fabricated from plastic.

The present disclosure provides for a positive static charge generating wheel 12P that is fabricated from a material operable to induce negative charge along an outer side 114 of belt 14 as belt 14 rotates clockwise thereby allowing the negative charge to be collected through negative electrode 122. In a further exemplary embodiment, negative static charge generating wheel 12N is fabricated from a material operable to induce a positive charge along side 114 of belt 14 as belt 124 rotates clockwise thereby allowing for positive charge to be collected through positive electrode 121. Belt 14 can be fabricated from any suitable material operable to generate positive and negative charges when rotated over wheels 12P and 12N. In an exemplary embodiment, belt 14 is fabricated from a rubber or a plastic material. In a further embodiment, positive static charge generating wheel 12P is fabricated from Nylon™ and negative static charge generating wheel is fabricated from Teflon™. Exemplary charge rotation is illustrated in FIG. 3 by the symbols (+) for positive and (−) for negative.

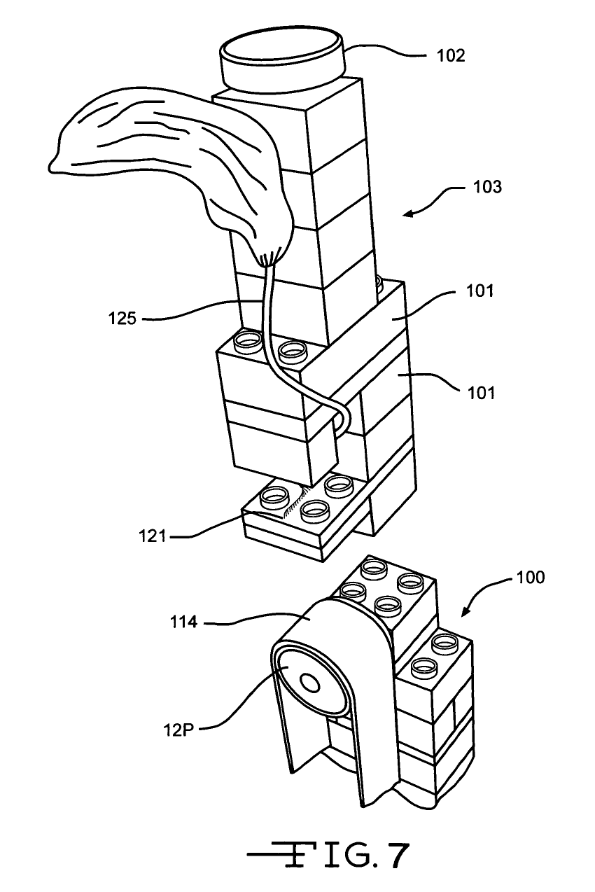

As can bee seen in FIG. 7, support structure 100 can further comprise an upper portion 103 also constructed by a plurality of building elements 101. In an exemplary embodiment, upper portion 103 is constructed together with electrode 121 that is connected to insulated wire 125. In a further embodiment, mounting member 102 is positioned on a top surface of upper portion 103 and provides an effective mounting surface for charge collector 120. Mounting member 102 can also be a magnet thus allowing for collector 120 to remain a more stabilized position over the electrode 121.

In an exemplary embodiment associated with the present disclosure, positive charge collector 120 is operable to deliver voltage from about 1,000 to 100,000 volts. In a particular embodiment, assembly 10 is operable to deliver voltage from about 1,000 to 30,000 volts. In a further embodiment, assembly 10 is operable to deliver voltage from about 5,000 to 15,000 volts. In a further embodiment, the collected negative charge is operable to create an electrical discharge lightning effect when positioned in proximity to a positively charged source, such as collector 120.

The voltage associated with a particular assembly 10 is highly dependent upon environmental conditions, such as humidity and temperature. Accordingly, certain materials can increase an/or decrease the amount of charge that can be generated. In an exemplary embodiment, positive electrostatic charge generating wheel 12P is further surrounded by a leather sleeve (not shown) to increase positive charge generation. In a further embodiment, a heating element (not shown) can be disposed internal to the belt and adapted to deliver heat to increase static charge generation.

The present disclosure provides for a kit having component parts capable of being assembled comprising: (a) a support structure comprising a plurality of friction fit building elements which are electrically non-conductive; (b) positive and negative static charge generating wheels to be spaced apart with respect to each other and secured on the support structure; (c) a belt to be wrapped around the spaced apart positive and negative static charge generating wheels; (d) a driving means for circumferentially rotating at least one of the positive and negative static charge generating wheels and the belt at a preselected rotational speed; (e) a connection means for providing a power source to be electrically coupled to the driving means; (f) positive and negative electrodes to be secured to the support structure adjacent to the belt, wherein each of the electrodes is mounted on at least one of the friction fit building elements and the positive electrode is to be positioned adjacent to the positive static charge generating wheel and operable to collect the positive static charge and the other negative electrode is to be positioned adjacent to the negative static charge generating wheel operable to collect the negative static charge; and (g) separate positive and negative static charge collectors to be mounted with respect to the positive and negative electrode respectively and are operable for storing the negative and positive static charges from the electrodes. A kit associated with the present disclosure typically includes instructions for assembly. In an exemplary embodiment, the kit can include a power source such as a battery. The kit can further include a power chord as the connection means operable to plug into a power source. Kits associated with the present disclosure can be used in a variety of applications including class room learning, investigative research or laboratory experimentation for example.

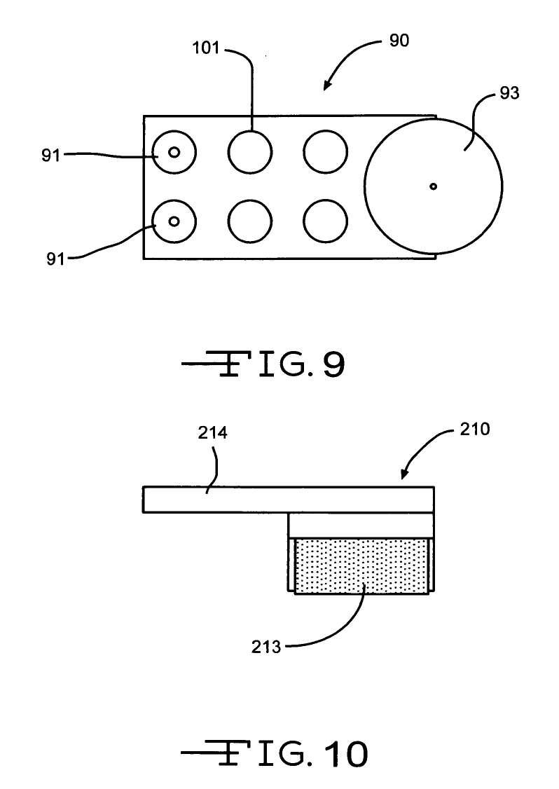

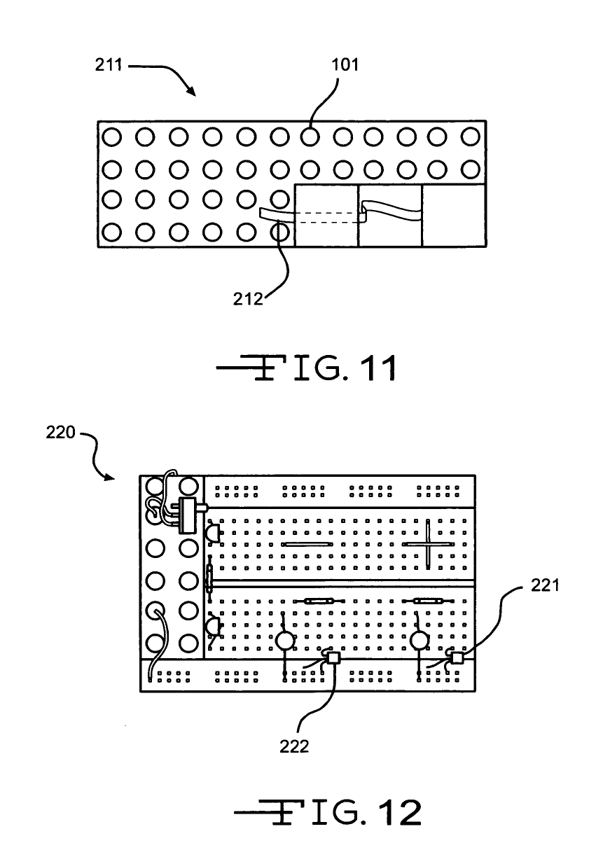

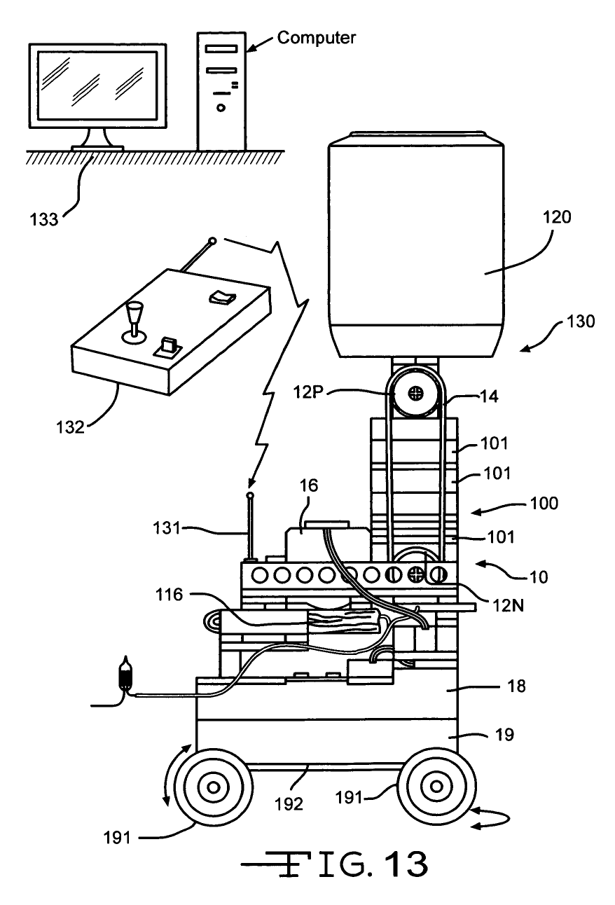

FIGS. 9, 11 and 12 illustrate additional components that are effective in illustrating and teaching the electrostatic principals associated with an exemplary assembly 10 described herein above. FIG. 9 shows a device 90 that comprise leads 91 for receiving electrostatic charge. If receiving enough voltage, device 90 makes noise through noise element 93. Leads 91 and noise element 93 can be fabricated on an exemplary building element 101. FIG. 11 illustrates a resonance indicator 211 comprising a building element 101 having a flimsy indicator 212. Indicator 212 includes a suspended portion that flaps back and forth when exposed to voltage. This allows for teaching and exploration of resonance principals. FIG. 12 illustrates an exemplary positive and negative light indication circuit board 220. Circuit board 222 is constructed to allow for positioning of resistors and transducers that each will respond to positive or negative charge delivery (voltage). In FIG. 12, transducer 221 allows for a light to turn on when exposed to positive voltage and transducer 222 allows for a light to turn on when exposed to a negative voltage.

As previously discussed, electrostatic charge generation is dependent upon several factors including environmental conditions. The friction of the moving belt is also a factor that can increase or reduce static charge generation. In an exemplary embodiment, a scraper brush 210 is utilized. Scraper brush 210 includes a handle 214 and a sand paper scraper portion 213. By allowing an exemplary belt 14 to interact or move along brush 210, increased frictional surface along the inner portion of the belt is achieved. This allows for greater charge generation during operation of assembly 110. Brush 210 should be sized and shaped to fit within the encircled section associated with belt 14.

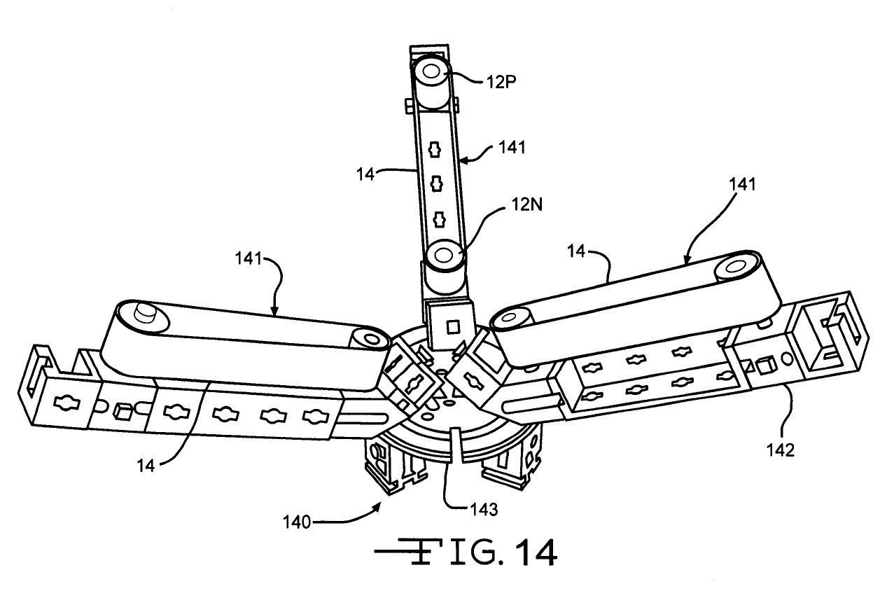

With reference to FIG. 13, the present disclosure provides for a robotic electrostatic charge generating apparatus 130 comprising: (a) an electrostatic charge generating assembly (similar to assembly 10 described hereinabove and therefore like numerals are used to describe like parts) comprising a support structure 100 and spaced apart positive (12P) and negative (12N) static charge generating wheels mounted with respect to support structure 100 surrounded by a belt 14 and coupled to a driving means (such as a motor) for rotating at least one of the positive or negative static charge generating wheels (12P or 12N) and belt 14 at a selected rotational speed; (b) separate positive 120 and negative 116 static charge collectors mounted with respect to positive and negative electrodes (121 and 122_ connected to the positive and negative electrostatic charge generating wheels (12P and 12N) respectively; (c) a power module 18 connected to the driving means; and (d) a robotic assembly 19 comprising: (i) a movable base 192, and (ii) robotically controlled motive means for moving the base from one place to another such as wheels 191. The electrostatic charge generating assembly 10 and the power module 18 are each mounted with respect to the movable base 192.

In an exemplary embodiment, the support structure is comprised of a plurality of friction fit building elements 101. In a further embodiment, power module 18 contains a battery. Typically power module 18 further includes means for activating the power source such as an on/off switch or on off buttons. The driving means can be a motor 16 electrically connected to the driving means. As previously discussed, motor 16 can be mechanically engaged with a gear system for turning at least one of the static charge generating wheels (12N or 12P).

In an exemplary embodiment, assembly 130 further comprises further comprising electronic control means in electronic communication with the robotic assembly 19. The electronic control means can include a programmable microprocessor hosted on assembly 130 and in electronic communication with the robotic assembly 19 and/or the motor 16. In a particular embodiment, the robotically controlled motive means comprises a plurality of wheels 191 on a base 192 driven by the control means. In a further embodiment, robotic assembly 19 includes four wheels 191. In a further embodiment, the robotic assembly comprises a tract (not shown) for enabling movement of base 192. The electronic control means (such as a microprocessor) can be in electronic communication with the driving means (such as motor 16) to control the rotational speed of static charge generating wheels (12P and 12N) and belt 14.

In an exemplary embodiment, the microprocessor is in wireless communication with a remote control device 132. Assembly 130 further includes a signal receiving device such as an antenna 131 for effectuating communication with remote control 132. Remote control device 132 is operable to deliver instructional signals to the microprocessor to drive the robotically controlled motive means (i.e., base 192 and wheels 191) to move the assembly 130 to a desired position. This allows for a movable and remotely controlled electrostatic charge generating device. Accordingly, for example, a user can deliver a desired voltage to a particular hard to reach location through the use of an exemplary assembly 130. In an exemplary embodiment, remote control device 132 is operable to deliver instructional signals to the microprocessor to drive the driving means (i.e., motor 16) to control the rotational speed of static charge generating wheels (12P and 12N) and belt 14. Controlling the speed of the wheels and belt effectively controls the voltage generated by the assembly.

In a further exemplary embodiment, assembly 130 comprises environmental sensors such as a humidity sensor (not shown) in electronic communication with the microprocessor. Since humidity plays a major roll in the voltage characteristics of a particular electrostatic generator, knowing environmental humidity can allow for more efficient and effective assembly operation. For example, if humidity is high, then sensor will feed that information to the microprocessor which will in turn increase the speed of the static charge generating wheel to reach a desired voltage. Accordingly, the rotational speed of the static charge generating wheels and the belt is adjusted as a result of the measurement made by the humidity sensor.

In an exemplary embodiment, the electronic control means (i.e., microprocessor) is a programmable microprocessor operable to control the rotational speed of the static charge generating wheels (12P and 12N) and belt 14 in order to generate a desired voltage from the positive (120) and negative (116) charge collectors. In an exemplary embodiment that includes a humidity sensor, the assembly 130 comprises a signaling means such as a lighting feature or an audio feature that provides adequate visual or audio indication to a user that a preprogrammed humidity condition has been reached. In an exemplary embodiment, the microprocessor receives instructional data from a programming source such as computer 133 via a wireless data communications architecture. A user can thus program the microprocessor to adjust voltage of assembly 130 through either the motor 16 or move assembly 130 through control of the robotic assembly 19.

In an exemplary embodiment, assembly 130 is operable to deliver a high voltage to a target. For example, the target can be bacteria and the bacteria are destroyed upon delivery of high voltage when exposed to one of the charge collectors. In an exemplary embodiment, the voltage delivered is from about 5,000 to 100,000 volts.

With reference to FIG. 14, the present disclosure provides for an exemplary multi-belt assembly 140 for collecting charge comprising a plurality of belt assemblies 141 supported on a base 143. Each belt assembly comprises a belt 14 wrapped around spaced apart positive and negative static charge generating wheels (12P and 12N). Each belt assembly is supported on a support member 142. The support member 142 is typically fabricated non-conductive material in an exemplary embodiment it is constructed from friction fit building elements 101. In the embodiment illustrated in FIG. 14, assembly 140 includes three belt assemblies 141 supported on base 143. Each assembly can be driving by its own motor or a single motor can be connected to all belt assemblies. In an exemplary embodiment, the motor controls the speed of the belt and is driven by a power source. In a further embodiment, the charges generated in each of the belt assemblies are collected together in a cumulative charge collector. In a further embodiment, the motor is in electronic communication with a control means such as a microprocessor to adjust the speed of the belts and thus the collected voltage.

While the present invention is described herein with reference to illustrated embodiments, it should be understood that the invention is not limited hereto. Those having ordinary skill in the art and access to the teachings herein will recognize additional modifications and embodiments within the scope thereof. Accordingly, such modifications and/or embodiments are considered to be included within the scope of the present invention.

We claim:

1. A static charge generating assembly comprising:
(a) a support structure comprising a plurality of friction fit building elements which are electrically non-conductive;
(b) positive and negative static charge generating wheels, wherein the wheels are spaced apart with respect to each other and secured on the support structure;
(c) a belt wrapped around the spaced apart positive and negative static charge generating wheels;
(d) a power source electrically coupled to a driving means for circumferentially rotating at least one of the positive and negative static charge generating wheels and the belt at a preselected rotational speed;
(e) positive and negative electrodes secured to the support structure adjacent to the belt, wherein each of the electrodes is mounted on at least one of the friction fit building elements and the positive electrode is positioned adjacent to the positive static charge generating wheel and operable to collect the positive static charge and the other negative electrode is positioned adjacent to the negative static charge generating wheel operable to collect the negative static charge; and
(f) separate positive and negative static charge collectors wherein each collector is mounted with respect to the positive and negative electrode respectively and are operable for storing the negative and positive static charges from the electrodes.

2. The assembly according to claim 1, wherein each of the electrodes each comprise a plurality of spaced apart electrically conductive lead wires connected to the separate static charge collectors.

3. The assembly according to claim 2, wherein each of the lead wires have terminals for transfer of the positive or the negative static charges to the charge collectors.

4. The assembly according to claim 3, wherein the positive static charge collector comprises a container fabricated from a charge collecting material and adapted to receive and store the positive static charge from the terminal from the positive electrode.

5. The assembly according to claim 4, wherein the positive charge collector is a metal container defining an opening cavity at a first end adapted to be mounted on the terminal for collection of the static charge from the positive electrode.

6. The assembly according to claim 3, wherein the terminal from the negative electrode is fabricated from an electrically conductive material and adapted to transfer negative static charge from the negative electrode to the negative static charge collector.

7. The assembly according to claim 6, wherein the terminal for the negative electrode is coupled to a conductive wire adapted to allow for the negative static charge to transfer through the terminal to the negative static charge collector.

8. The assembly according to claim 6, wherein the positive and negative charge terminals are removably secured within the support structure.

9. The assembly according to claim 1, wherein the plurality of friction fit building elements each define a three dimensional geometry.

10. The assembly according to claim 9, wherein the three dimensional geometries are selected from the group consisting of rectangle, square, disk and combinations thereof.

11. The assembly according to claim 9, wherein each of the building elements defines a plurality of sides and comprises:
(i) a main body;
(ii) at least one outwardly extending friction fit member on at least a first side defining a first geometry;
(iii) at least one friction fit receptacle defined on at least a second side defining a second geometry adapted to receive an outwardly extending friction fit member from another building element defining the first geometry.

12. The assembly according to claim 11, wherein the first geometry is selected from the group consisting of circle, triangle, square, rectangle, pentagon, hexagon, heptagon and octagon.

13. The assembly according to claim 11, wherein the outwardly extending friction fit member defines a circular geometry and a hollow cavity portion in the center.

14. The assembly according to claim 1, wherein the positive static charge generating wheel is fabricated from a material operable to generate negative charge along an outer side of the belt and wherein the negative static charge generating wheel is fabricated from a material operable to generate a negative charge along the outside of the belt.

15. The assembly according to claim 1, wherein the belt is fabricated from a rubber or a plastic material.

16. The assembly according to claim 1, wherein the building elements are fabricated from plastic.

17. The assembly according to claim 1, wherein the driving means comprises:
(i) a large gear engaged with respect to a motor driven by the power source;
(ii) a small gear driven by the large gear and engaged with the negative static charge generating wheel.

18. The assembly according to claim 17, wherein the power source defines a top surface of friction fit building elements and the support structure is positioned and supported on the top surface of the power source.

19. The assembly according to claim 17, wherein the large gear, the small gear and the motor are each removably mounted with respect to the support structure.

20. The assembly according to claim 1, wherein the power source is embedded in at least one friction fit building element.

21. The assembly according to claim 5, wherein the positive charge collecting assembly collects positive charge to deliver from about 1,000 to 100,0000 volts.

22. The assembly according to claim 5, wherein the positive charge collecting assembly collects positive charge to deliver from about 5,000 to 15,000 volts.

23. The assembly according to claim 7, wherein the collected negative charge is operable to create an electrical discharge lightning effect when positioned in proximity to a positively charged source.

24. The assembly according to claim 1, wherein the positive electrostatic charge generating wheel is further surrounded by a leather sleeve to increase positive charge generation.

25. The assembly according to claim 1, further comprising a heating element disposed internal to the belt and adapted to deliver heat to increase static charge generation.

26. A kit having component parts capable of being assembled comprising:
(a) a support structure comprising a plurality of friction fit building elements which are electrically non-conductive;
(b) positive and negative static charge generating wheels to be spaced apart with respect to each other and secured on the support structure;
(c) a belt to be wrapped around the spaced apart positive and negative static charge generating wheels;
(d) a driving means for circumferentially rotating at least one of the positive and negative static charge generating wheels and the belt at a preselected rotational speed;
(e) a connection means for providing a power source to be electrically coupled to the driving means;
(f) positive and negative electrodes to be secured to the support structure adjacent to the belt, wherein each of the electrodes is mounted on at least one of the friction fit building elements and the positive electrode is to be positioned adjacent to the positive static charge generating wheel and operable to collect the positive static charge and the other negative electrode is to be positioned adjacent to the negative static charge generating wheel operable to collect the negative static charge; and
(g) separate positive and negative static charge collectors to be mounted with respect to the positive and negative electrode respectively and are operable for storing the negative and positive static charges from the electrodes.

27. The kit of claim 26, further comprising instructions for assembly.

28. The kit of claim 26, further comprising a power source.

29. The kit of claim 28, wherein the power source is a battery.

30. The kit of claim 28, wherein the power source is embedded in at least one friction fit building element.

31. The kit of claim 26, wherein the connection means is a power chord operable to plug into a power source.

32. A robotic electrostatic charge generating apparatus comprising:
(a) an electrostatic charge generating assembly comprising a support structure and spaced apart positive and negative static charge generating wheels mounted with respect to the support structure surrounded by a belt and coupled to a driving means for rotating at least one of the positive or negative static charge generating wheels and the belt at a selected rotational speed;
(b) separate positive and negative static charge collectors mounted with respect to positive and negative electrodes connected to the positive and negative static charge generating wheels respectively;
(c) a power module connected to the driving means; and
(d) a robotic assembly comprising programmable element adapted to receive instructional data and effectuate adjustments in at least the rotational speed of the driving means.

33. The apparatus of claim 32, wherein the robotic assembly further comprises (i) a movable base; and (ii) robotically controlled motive means for moving the base from one place to another.

34. The apparatus of claim 33, wherein the electrostatic charge generating assembly and the power module are each mounted with respect to the movable base.

35. The apparatus of claim 32, wherein the support structure is comprised of a plurality of friction fit building elements.

36. The apparatus of claim 32, wherein the power module is a battery.

37. The apparatus of claim 32, wherein the power module is embedded in a friction fit building element.

38. The apparatus of claim 32, wherein the driving means is a plurality of gears driven by a motor wherein at least one of the gears mechanically drives at least one of the positive or negative electrostatic charge generating wheels.

39. The apparatus of claim 33, further comprising electronic control means in electronic communication with the robotically controlled motive means.

40. The apparatus of claim 33, wherein the robotically controlled motive means comprises a plurality of wheels driven by the control means.

41. The apparatus of claim 40, wherein plurality of wheels comprises four wheels.

42. The apparatus of claim 33, wherein the robotically controlled motive means comprises a tract for enabling movement of the base.

43. The apparatus of claim 39, wherein the electronic control means is a microprocessor.

44. The apparatus of claim 39, wherein the electronic control means is in electronic communication with the driving means to control the rotational speed of static charge generating wheels and the belt.

45. The apparatus of claim 39, wherein the electronic control means is a microprocessor in wireless communication with a remote control device.

46. The apparatus of claim 45, wherein the remote control device is operable to deliver instructional signals to the microprocessor to drive the robotically controlled motive means to move the robotic apparatus to a desired position.

47. The apparatus of claim 44, wherein the remote control device is operable to deliver instructional signals to the microprocessor to drive the driving means to control the rotational speed of static charge generating wheels and the belt.

48. The apparatus of claim 44, further comprising a humidity sensor connected to the electronic control means operable to measure surrounding environmental humidity.

49. The apparatus of claim 48, wherein the rotational speed of the static charge generating wheels and the belt is adjusted as a result of the measurement made by the humidity sensor.

50. The apparatus of claim 44, wherein the electronic control means is a programmable microprocessor operable to control the rotational speed of the static charge generating wheels and the belt in order to generate a desired voltage from the positive and negative charge collectors.

51. The apparatus of claim 48, further comprising signaling means for indicating when the environment has reached a target humidity value based on the humidity sensor.

52. The apparatus of claim 51, wherein the signaling means is visual characterized by at least one lighting feature lighting when the environment reaches a target humidity value.

53. The apparatus of claim 51, wherein the signaling means is auditory and delivers an auditory noise when the environment reaches a target humidity value.

54. The apparatus of claim 32, wherein the charge collectors are operable to deliver a high voltage to a target.

55. The apparatus of claim 32, wherein the target is bacteria and is destroyed upon delivery of high voltage when exposed to one of the charge collectors.

56. The apparatus of claim 54, wherein the voltage delivered is from about 5,000 to 100,000 volts.

57. An electrostatic charge generating apparatus comprising:
(a) a plurality of electrostatic charge generating belt assemblies wherein each belt assembly is comprised of a support structure and spaced apart positive and negative static charge generating wheels mounted with respect to the support structure surrounded by a belt and coupled to a driving means for rotating at least one of the positive or negative static charge generating wheels and the belt at a selected rotational speed;
(b) separate positive and negative static charge collectors mounted with respect to positive and negative electrodes connected to the positive and negative static charge generating wheels respectively;
(c) a connection means for connecting the driving means to a power source; and
(d) a base for supporting the plurality of belt assemblies.

58. The assembly of claim 57, wherein the base supports three circumferentially spaced apart belt assemblies.

59. The assembly of claim 57, wherein the support structure is constructed from a plurality of friction fit building elements.

60. The assembly of claim 57, wherein the plurality of belt assemblies are driven by a single motor.
